(19) United States
(12) Patent Application Publication
(10) Pub. No.: US 2007/0032231 A1
(43) Pub. Date: Feb. 8, 2007

(54) Telephone, telephone directory data checking method, and telephone directory data checking program

(75) Inventor: Tomohiro Yoshii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/282,630

(22) Filed: Nov. 21, 2005

(30) Foreign Application Priority Data
Aug. 2, 2005 (JP) 2005-223553

(51) Int. Cl. H04Q 7/20

(52) U.S. Cl. 455/426.1

(57) ABSTRACT

A telephone directory data checking unit detects repeatedly registered telephone directory data by checking caller information about a received voice communication or transmitter information about received e-mail with all telephone directory data registered in the telephone directory, and stores information for identification of telephone directory data having the checking result which indicates correspondence in the repetition information storage unit every time when a checking result indicates correspondence. A display unit performs screen display for notifying that telephone directory data has been repeatedly registered according to the information stored in the repetition information storage unit when the repeatedly registered telephone directory data is detected.

### CROSS-REFERENCE TO RELATED APPLICATIONS

This application claims the conventional priority based on Japanese Patent Application Serial No. 2005-223553, filed on Aug. 2, 2005, the disclosures of which are incorporated herein by reference.

### BACKGROUND OF THE INVENTION

1. Field of the Invention

This invention generally relates to a telephone, a telephone directory data checking method and a telephone directory data checking program, and more particularly to a telephone, a telephone directory data checking method and a telephone directory data checking program, the telephone storing telephone directory data and implementing a function of receiving a voice communication call and e-mail, and the telephone checking the caller information about a received voice communication call or the transmitter information about received e-mail with the telephone directory data to notify a repeatedly registered telephone directory data.

2. Description of the Related Art

For example, the amount of telephone directory data which can be registered in a mobile telephone has greatly increased, and the operability of a mobile telephone has been largely enhanced. A user can register telephone directory data in a telephone directory in an easy operation. When the user receives a voice communication call (an incoming telephone call) from a specific partner, or e-mail, the contents of an output process (an incoming call processing) of notifying the user of the reception can be set in advance in the mobile telephone. It is well known that the incoming call processing is performed normally by a voice communication output or a vibration output. For example, depending on a specific partner, a specific ringing tone or a vibration output is set.

For example, there is a telephone device which updates telephone directory data based on the telephone number and the name of a caller notified when a voice communication call is received (for example, refer to a patent document 1: Japanese Patent Application Laid-Open No. 2003-60775). There is also a telephone device which checks a received source number information with telephone numbers registered in advance for each group when a voice communication call is received, and outputs as voice communication a name of a group and an individual name based on the checking result (for example, refer to a patent document 2: Japanese Patent Application Laid-Open No. 2000-115350).

When there are hundreds of telephone directory data, for example, it is troublesome for a user to search whether or not a newly received telephone number or a mail address of an e-mail (hereinafter referred to as registration candidate data) has already been registered, when a voice communication call or e-mail is received. Therefore, the user often registers the registration candidate data without searching whether or not the data has already been registered. Thus, an increasing capacity of a telephone directory unfortunately increases a large amount of repeatedly registered telephone directory data.

When there is repeatedly registered telephone directory data, different incoming call processing can be set for each telephone directory data. Therefore, depending on the checking order of telephone directory data, the incoming call processing, which is set for the telephone directory data referring to the first corresponding (or hit) with a received telephone number or a mail address, can be different from the incoming call processing intended by a user (or latest set by the user).

The incoming call processing performed in this case is the incoming call processing which is set for the first hit telephone number or mail address in the checking process on telephone directory data. Therefore, the incoming call processing of a mobile telephone can be different from the user-intended incoming call processing. As a result, it is hard for the user to detect the sender of a received voice communication call or e-mail.

### SUMMARY OF THE INVENTION

It is an object of the present invention to provide a telephone capable of allowing a user to recognize repeatedly registered telephone directory data without searching telephone directory data by the user.

It is an another object of the present invention to provide a telephone directory data checking method capable of allowing a user to recognize repeatedly registered telephone directory data without searching telephone directory data by the user.

It is still another object of the present invention to provide a telephone directory data checking program capable of allowing a user to recognize repeatedly registered telephone directory data without searching telephone directory data by the user.

The telephone of the present invention comprises a telephone directory registering at least a telephone directory data, a storage unit, a telephone directory data checking unit, and a notification unit. The telephone directory data checking unit detects one or more repeatedly registered telephone directory data by checking a caller information about a received voice communication or a transmitter information about a received e-mail with all telephone directory data registered in the telephone directory, and stores information for identification of the telephone directory data having a checking result which indicates correspondence in the storage unit every time when a checking result indicates correspondence. The notification unit notifies that the telephone directory data is repeatedly registered according to the information stored in the storage unit when the repeatedly registered telephone directory data is detected.

Preferably, in the telephone of the present invention, the telephone directory data checking unit detects the repeatedly registered telephone directory data by a trigger of receiving the voice communication or the e-mail.

Preferably, the telephone of the present invention further comprises a repeated registered data deletion unit deleting telephone directory data to be deleted from the repeatedly registered telephone directory data. The repeated registered data deletion unit updates an incoming call processing information corresponding to telephone directory data not to be deleted in the telephone directory by using an incoming call processing information corresponding to the telephone directory data to be deleted.

The telephone directory data checking method checks a telephone directory data registered in a telephone directory of a telephone. The method comprises detecting a repeatedly registered telephone directory data by checking a caller information about a received voice communication or a transmitter information about a received e-mail with all telephone directory data registered in the telephone directory, storing information for identification of the telephone directory data having the checking result which indicates correspondence in a storage unit every time when the checking result indicates correspondence, and notifying that the telephone directory data is repeatedly registered according to the information stored in the storage unit when the repeatedly registered telephone directory data is detected.

The telephone directory data checking program checks telephone directory data registered in a telephone directory of a telephone having a computer. The program causes the computer to execute detecting a repeatedly registered telephone directory data by checking a caller information about a received voice communication or a transmitter information about a received e-mail with all telephone directory data registered in the telephone directory, storing information for identification of the telephone directory data having the checking result which indicates correspondence in a storage unit every time when a checking result indicates correspondence, and notifying that the telephone directory data is repeatedly registered according to the information stored in the storage unit when the repeatedly registered telephone directory data is detected.

According to the telephone, the telephone directory data checking method, and the telephone directory data checking program of the present invention, for example, when a voice communication call or an e-mail is received, caller information or transmitter information is checked with the telephone directory data registered in the telephone directory. At this time, even when the caller information or the transmitter information corresponds with the telephone directory data (a checking result indicates correspondence or hitting), the checking process is not suspended, but is continued while there is unchecked telephone directory data. Therefore, all telephone directory data is checked. Every time when a checking result indicates correspondence, the information identifying the telephone directory data having the checking result which indicates correspondence is stored, and a user is notified of the repeatedly registered telephone directory data according to the stored information.

Thus, the telephone directory data is searched without the user performing a searching operation, and the user can be notified of repeatedly registered telephone directory data based on the result. Therefore, for example, unnecessary telephone directory data can be deleted in a user operation by showing repeatedly registered telephone directory data to the user.

Furthermore, according to the present invention, the telephone detects the repeatedly registered telephone directory data when the voice communication call is received or the e-mail is received. Thus, a user can detect repeatedly registered telephone directory data without paying special attention, thereby reducing the load of the user in managing the telephone directory.

Additionally, according to the present invention, the telephone deletes the telephone directory data to be deleted from the repeatedly registered telephone directory data, and updates an incoming call processing information corresponding to the telephone directory data not to be deleted by using an incoming call processing information corresponding to the telephone directory data to be deleted. Thus, when unnecessary telephone directory data is deleted, only the necessary data is reserved, and it is reflected by other (to be remained) repeatedly registered telephone directory data. Therefore, the telephone directory can be adjusted without the user inputting again the necessary partial data, thereby reducing the load of the user in managing the telephone directory.

### BRIEF DESCRIPTION OF THE DRAWINGS

FIG. 1 is a diagram showing an example of a structure of a telephone of the present invention.

FIG. 2 is a diagram showing an example of a data structure of a telephone directory.

FIG. 3 is a diagram showing an example of a data structure in a repetition information storage unit.

FIG. 4 is a diagram showing an example of a data structure in a history data storage unit.

FIGS. 5A and 5B show screen examples notifying that there are repeatedly registered data.

FIGS. 6A, 6B, and 6C show screen examples notifying that there are repeatedly registered data.

FIGS. 7A and 7B are diagrams showing display examples of submenus or display examples of repeatedly registered data.

FIGS. 8A and 8B are diagrams showing display examples of submenus or display examples of selection screens.

FIG. 9 is a diagram showing an example of the structure of the data of the telephone directory.

FIG. 10 shows an example of a checking process of telephone directory data.

FIG. 11 shows an example of a deleting process flow of repeatedly registered telephone directory data.

### DETAILED DESCRIPTION OF THE PREFERRED EMBODIMENTS

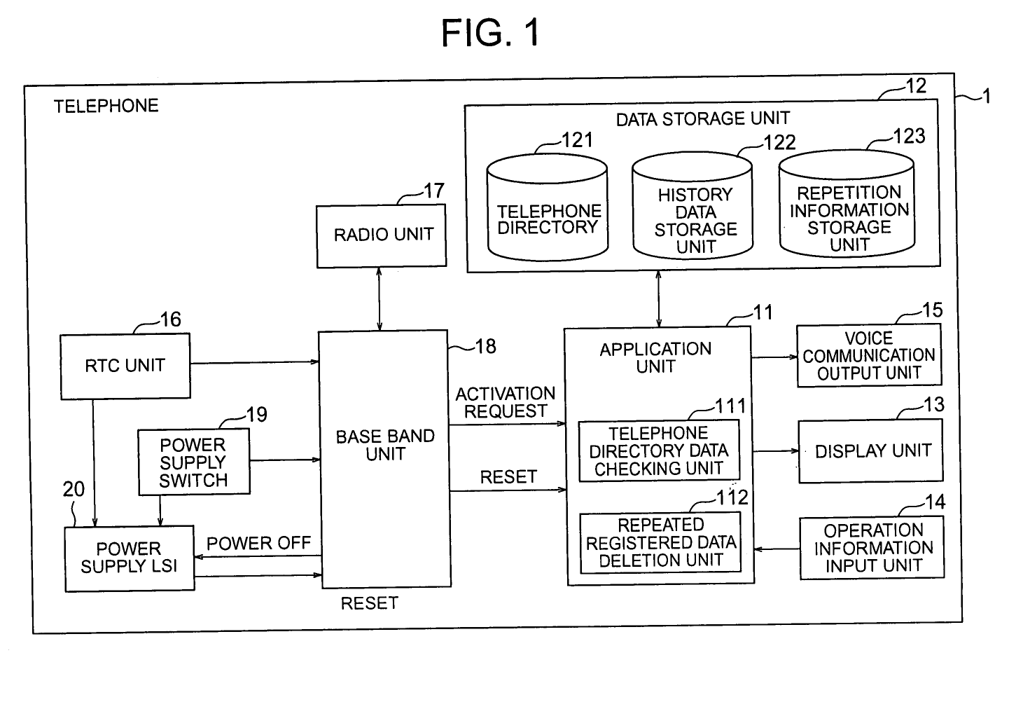

FIG. 1 is a diagram of a structure of a telephone, and shows an example of the structure of the telephone of the present invention. A telephone (telephone device or apparatus) 1 is, for example, a mobile telephone. In this example, the telephone 1 has the function of a normal telephone (mobile telephone) and the function of e-mail. The telephone 1 can further has the function of, for example, connecting to the Internet. The telephone 1 may be a fixed telephone so far as it is provided with an electronic telephone directory 121 (that is, telephone directory which stores electronic data) on a storage device.

First, the well-known functions of the telephone 1 are briefly explained below. A radio unit 17 transmits a signal received from an external unit (for example, an antenna mounted on the street) of the telephone 1 by wireless communication to a base band unit 18, and the radio unit 17 transmits by wireless communication a signal received from the base band unit 18 to the external unit of the telephone 1. The base band unit 18 modulates the signal to be transmitted to the radio unit 17, and demodulates the signal received from the radio unit 17. When a voice communication call (incoming telephone call) or e-mail is received, the base band unit 18 transmits an activation request to an application unit 11, receives the signal received by the radio unit 17 from the radio unit 17 and demodulates it, and transmits it to the application unit 11. When a voice communication call or e-mail is transmitted, the base band unit 18 receives a signal from the application unit 11 and modulates it, and transmits it to the radio unit 17. Furthermore, the base band unit 18 issues a reset request as necessary to the application unit 11.

Although it is not necessary to distinguish a voice communication call from e-mail when receiving them, they are distinguished in the present example. FIG. 1 mainly shows the reception of voice communication call and e-mail, and the transmitting process is omitted here.

The application unit 11 performs incoming call processing on a received voice communication call or e-mail when the application unit 11 receives an activation request from the base band unit 18. That is, at an instruction from the application unit 11, a voice communication output unit 15 outputs voice communication for notification of the reception of an incoming call for a user according to the incoming call processing information (described later) set by the telephone directory data of the telephone number or e-mail address in the telephone directory 121. The telephone 1 may be provided with the function (not shown in the attached drawings) of performing a vibrating operation according to the incoming call processing information. At an instruction from the application unit 11, a display unit 13 displays a notification of the reception of voice communication call or e-mail for a user. The display unit 13 includes, for example, an LCD (liquid crystal display), for example, and has a display screen. The voice communication output unit 15 includes, for example, a speaker and a microphone, for example. It is assumed that the voice communication output unit 15 includes a voice communication input unit (that is, it is a voice communication input/output unit).

The application unit 11 performs a process depending on the operation on the operation screen displayed on the display unit 13 of the telephone 1. For example, it switches a screen, displays a submenu, for example. That is, at an instruction of the application unit 11, the display unit 13 displays an operation result by an operation information input unit 14 on the screen. The operation information input unit 14, as is generally known, includes a plurality of input keys (buttons). The operation information input unit 14 inputs the operation information of the telephone 1 based on the key operation of a user. The operation information can be, for example, a telephone number, an e-mail address, instruction information about an issue of a telephone call or e-mail, instruction information about the display of an incoming call history, instruction information about the display of the telephone directory 121, instruction information about the display of a list of received e-mail, instruction information about the display of a submenu, for example. By a user key operation or selection of a display on the screen by a user key operation, the operation information can be input.

An RTC (real time clock) unit 16 generates time information and transmits it to the base band unit 18 and a power supply LSI 20. A power supply switch 19 is a switch of the telephone 1 including, for example, the power key of the operation information input unit 14. The power supply LSI 20 supplies electric power to the telephone 1 when the power supply switch 19 is turned on. The base band unit 18 notifies the power supply LSI 20 of the power-off when the end of communication is detected. Accordingly, the power supply LSI 20 notifies the base band unit 18 of a reset, and the base band unit 18 notifies the application unit 11 of the reset. After the power cutoff process by the base band unit 18 and the application unit 11, the power supply LSI 20 turns off the power supply.

The application unit 11 performs the checking process on the telephone directory data registered in the telephone directory 121 using the telephone directory data checking unit 111. In this example, the checking process is performed before the above-mentioned incoming call processing without an input by a user (without special user attention) according to the present invention. The application unit 11 also performs the deleting process using a repeated registered data deletion unit 112 on repeatedly registered telephone directory data in the telephone directory 121 according to the present invention. In the deleting process, necessary input of instructions is made by a user using the display unit 13 and the operation information input unit 14 as described later.

The application unit 11 is realized by the CPU and a program executed by the CPU. The program for realizing the present invention can be stored in a computer-readable recording medium, for example, semiconductor memory, a hard disk, CD-ROM, DVD and so on, provided through a communication interface by communication over a network.

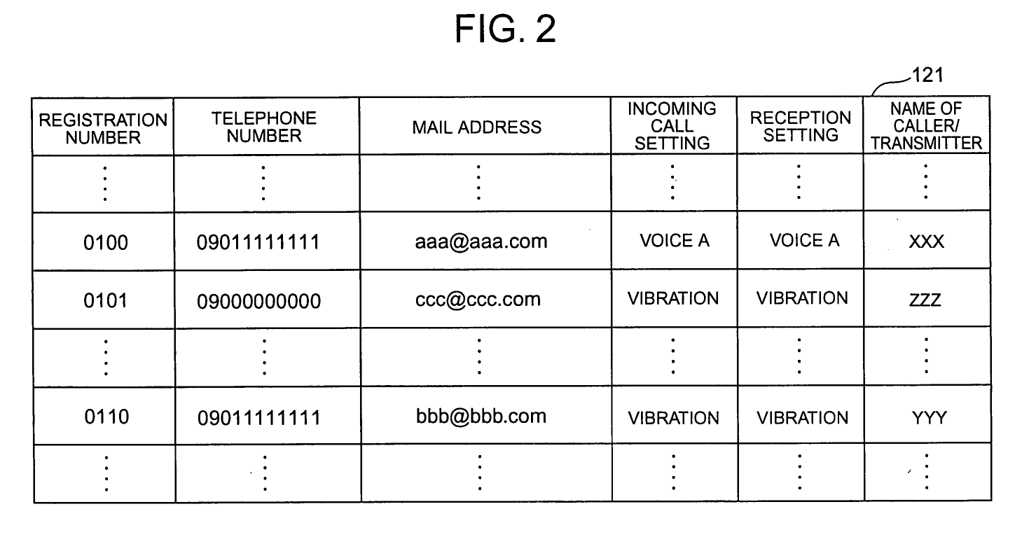

FIG. 2 is a diagram showing an example of a data structure of the telephone directory 121. The telephone directory 121 is provided in a data storage unit 12 as shown in FIG. 1. The data storage unit 12 includes, for example, non-volatile memory such as flash memory and so on. The telephone directory 121 includes a plurality (for example, 500) of telephone directory data registered therein. In this example, the telephone directory data registered in the telephone directory 121 includes data associated with the incoming call processing information when a voice communication call or e-mail is received.

As shown in FIG. 2, the telephone directory data includes, for example, a registration number, a telephone number, an mail address, incoming call setting, reception setting, the name of a caller/transmitter. The registration number includes the registration number indicating the registration order of telephone directory data in the telephone directory 121. A telephone number includes the telephone number of a caller in a voice communication. An mail address includes an mail address of the transmitter of e-mail. Incoming call setting includes the incoming call processing information when a voice communication call is received, that is, an operation (contents of incoming call processing) performed when a voice communication call corresponding to the telephone number is received. The incoming processing information used when e-mail is received, that is, the operation performed when e-mail is received corresponding to the mail address (contents of incoming call processing), is set as reception setting. Therefore, the incoming call processing information includes incoming call setting and reception setting. The name of a caller/transmitter includes the name of the caller of the voice communication or the transmitter of the e-mail.

A telephone directory data checking unit 111 detects repeatedly registered telephone directory data in the telephone directory 121 when a voice communication call or e-mail is received. Correctly, when a voice communication call or e-mail is received, the application unit 11 is activated at an activation request from the base band unit 18, and the activated application unit 11 instructs the telephone directory data checking unit 111 to detect repeatedly registered telephone directory data in the telephone directory 121.

That is, the telephone directory data checking unit 111 extracts the caller information about the received voice communication call or the transmitter information about the received e-mail from the received voice communication call or the received e-mail. The caller information includes, for example, a telephone number, and the transmitter information includes, for example, a mail address. The telephone directory data checking unit 111 checks the extracted caller information about the voice communication call or the transmitter information about the received e-mail with all telephone directory data registered in the telephone directory 121, thereby detecting repeatedly registered telephone directory data. When there is repeatedly registered telephone directory data, the telephone directory data checking unit 111 directs the display unit 13 to display a notification screen notifying to a user that the telephone directory data is repeatedly registered.

The checking order of telephone directory data is, for example, the registration (registration number) order of the telephone directory data in the telephone directory 121. Otherwise, it may be the alphabetical order or the order of kana characters of the names of callers of the registered telephone directory data, or the numerical order (memory number) of the area storing the telephone directory data in the telephone directory 121. The memory number is a unique number assigned to the storage area of each of telephone directory data in the telephone directory 121.

The telephone directory data checking unit 111 stores the information identifying the telephone directory data having the checking result which indicates correspondence (that is, repeatedly registered data) in a repetition information storage unit 123 of the data storage unit 12. That is, although a hit is found in one of telephone directory data, the checking process is not suspended but continued and performed until the last of the telephone directory data is checked. Thus, telephone numbers or mail addresses are checked without useless checking process.

In the present invention, all hit telephone directory data is detected, and repeatedly registered data is detected when one of telephone directory data indicating a hit is found. Therefore, repeatedly registration refers to the status in which at least one same telephone number or mail address as the telephone number or mail address of the received voice communication call or e-mail (registration candidate data) has already been registered in the telephone directory 121. Repeatedly registered telephone directory data refers to the telephone directory data in the above-mentioned status.

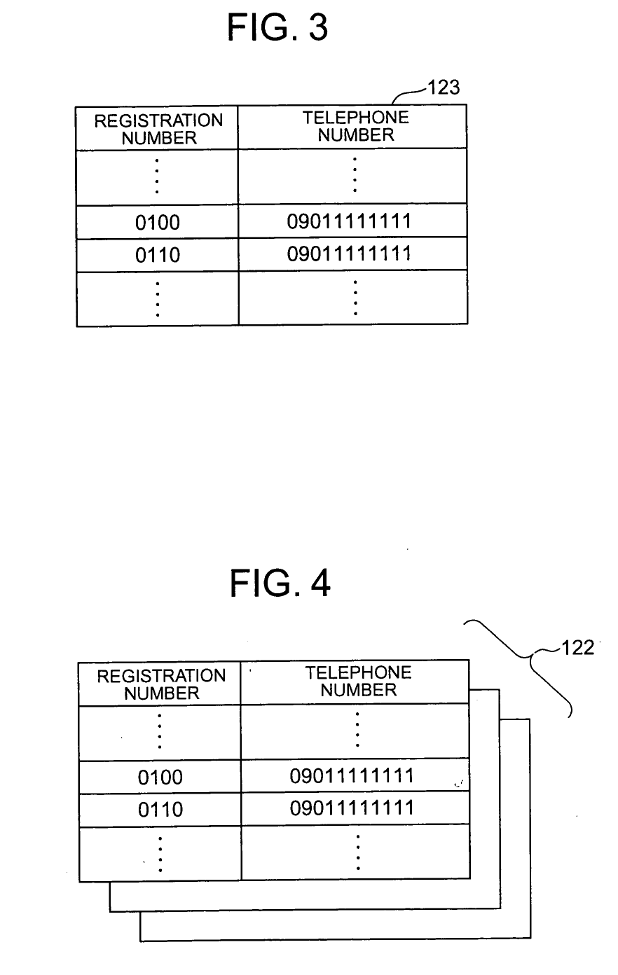

FIG. 3 is a diagram showing an example of the data structure of the repetition information storage unit 123. FIG. 3 shows an example of a voice communication call, but a similar example can be applied to e-mail. The repetition information storage unit 123 is provided for the data storage unit 12 for example as shown in FIG. 1. The data storage unit 12 includes, in addition to the telephone directory 121, the repetition information storage unit 123 and a history data storage unit 122 (described later). The history data storage unit 122 and the repetition information storage unit 123 can be stored in (volatile) memory such as DRAM and so on.

As shown in FIG. 3, the repetition information storage unit 123 stores identification information for identifying telephone directory data having the checking result which indicates correspondence. The identification information includes, for example, a registration number and a telephone number. The registration number includes a registration number indicating the registration order of the telephone directory data in the telephone directory 121. The telephone number includes a set telephone number.

The identification information is not limited to the identification information shown in FIG. 3 so far as telephone directory data having the checking result which indicates correspondence can be identified. For example, in the identification information, a registration number may be replaced with a memory number of the telephone directory 121 of the telephone directory data. Otherwise, as the identification information (in place of the identification information), the repeatedly registered telephone number itself can also be stored.

In this example, as described above, after the telephone directory data checking unit 111 checks the caller information about a received voice communication call or the transmitter information about a received e-mail with all telephone directory data, it performs incoming call processing according to the incoming call processing information on the received voice communication call or the received e-mail. At this time, in the present example, the telephone directory data checking unit 111 performs incoming call processing according to the incoming call processing information on the first telephone directory data having the checking result which indicates correspondence. For example, the ringing tone set according to the incoming call processing information is raised. Thus, the user can be informed of the caller or the transmitter of the voice communication call or e-mail.

The telephone directory data checking unit 111 can perform incoming call processing according to the incoming call processing information corresponding to the telephone directory data having the checking result which indicates correspondence in a predetermined order. For example, the incoming call processing may be performed according to the incoming call processing information about the last telephone directory data having the checking result which indicates correspondence. The incoming call processing may be performed according to the incoming call processing information about the telephone directory data having the largest memory number in the telephone directory 121 and indicating a checking result. Thus, the incoming call processing information about the last registered telephone directory data may be prioritized.

On the other hand, when there is no telephone directory data having the checking result which indicates correspondence with the caller information about the received voice communication call or the transmitter information about the received e-mail, the telephone directory data checking unit 111 performs normal incoming call processing. That is, the telephone directory data checking unit 111 performs the incoming call processing according to predetermined incoming call processing information in the application unit 11 as incoming call processing on the received voice communication call or e-mail. As a result, for example, a normal ringing tone is raised.

Immediately after detecting the first telephone directory data having the checking result which indicates correspondence with the caller information about the received voice communication call or the transmitter information about the received e-mail, the telephone directory data checking unit 111 can perform incoming call processing on the received voice communication call or e-mail. In this case, the telephone directory data checking unit 111 performs the incoming call processing according to the incoming call processing information corresponding to the first telephone directory data having the checking result which indicates correspondence. The telephone directory data checking unit 111 performs the incoming call processing and the checking process in parallel or performs the checking process after the incoming call processing.

According to the result of the checking process, in the present invention, a notifying process of notifying a user of repeatedly registered telephone directory data is performed. The notifying process is performed by the application unit 11 and the display unit 13 for displaying data at an instruction from the application unit 11. Therefore, it can be considered that the notification unit is configured by the application unit 11 and the display unit 13. That is, the application unit 11 and the display unit 13 (hereinafter referred to simply as the application unit 11) as a notification unit notify that there is repeatedly registered telephone directory data according to the information stored in the data storage unit 12 when the repeatedly registered telephone directory data is detected. That is, the application unit 11 displays a notification screen notifying that there is repeatedly registered telephone directory data.

The notification is issued when a voice communication call is received, when e-mail is received, when an incoming call history display instruction is input, when received mail listing display instruction is input, or when a display instruction of the telephone directory 121 is input. In this example, the notification screen is displayed at any of the triggers. The display of the notification screen may be replaced with voice output or vibration so that the notification can be given.

As described above, the data storage unit 12 includes the repetition information storage unit 123 as the first storage unit and the history data storage unit 122 as the second storage unit. The telephone directory data checking unit 111 stores the information identifying telephone directory data having the checking result which indicates correspondence in the repetition information storage unit 123, and after the incoming call processing on the received voice communication call or e-mail, it stores (transfers) the information stored in the repetition information storage unit 123 in the history data storage unit 122. At this time, the information stored in the repetition information storage unit 123 is deleted. Therefore, the identification information in the repetition information storage unit 123 is an information for identifying repeatedly registration of the voice communication call or e-mail currently being received.

FIG. 4 is a diagram showing an example of the data structure of the history data storage unit 122. FIG. 4 shows an example of voice communication call, but a similar example can be applied to e-mail. As shown in FIG. 4, the history data storage unit 122 stores the identification information about the repetition information storage unit 123 as it is every time when the data is stored (transferred). Therefore, the history data storage unit 122 stores a plurality of identification information for identifying the telephone directory data having the checking result which indicates correspondence on a plurality of telephone numbers or mail address for each telephone number or mail address or e-mail. The identification information includes, for example, a registration number and a telephone number. Therefore, a plurality of identification information in the history data storage unit 122 is information for identifying repeatedly registration on the voice communication call or e-mail received in the past. The identification information in the history data storage unit 122 is stored until, for example, a user displays or deletes the repeatedly registered telephone directory data. Thus, until the information is displayed to the user, or until the user deletes the information, the identification information can be stored.

In this example, the application unit 11 displays the notification screen for notifying that the telephone directory 121 includes repeatedly registered telephone directory data when a voice communication call or e-mail is received. In this case, the notification screen is displayed based on the information stored in the repetition information storage unit 123 of the data storage unit 12.

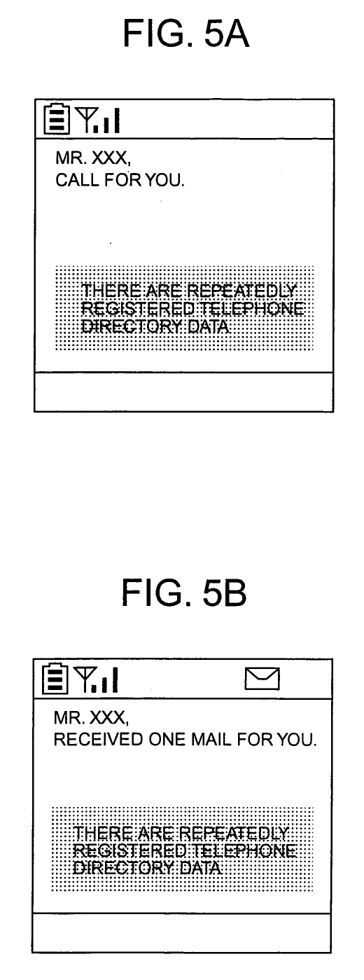

For example, when a voice communication call is received, the application unit 11 displays the notification screen notifying that there is repeatedly registered data as shown in FIG. 5A. When e-mail is received, the application unit 11 also displays the notification screen notifying that there is repeatedly registered data as shown in FIG. 5B. Thus, the user can be informed that the telephone directory 121 includes repeatedly registered telephone directory data (also referred to as repeatedly registered data). Although the repeatedly registered telephone directory data cannot be deleted after the notification (display), the information stored in the repetition information storage unit 123 is transferred to the history data storage unit 122 after the corresponding communication (that is, after the corresponding communication is performed or contents of e-mail are displayed). The notification screen is prepared for the application unit 11 (or data storage unit 12) in advance (the same with the other screens).

The application unit 11 can also display the notification screen when an incoming call history display instruction is input, a received mail listing display instruction is input, or when a display instruction of the telephone directory 121 is input. That is, after the communication relating to the reception of a voice communication call or e-mail as a trigger of the checking process, the notification screen may be displayed. The above-mentioned display instructions are given by the user using the operation information input unit 14. Thus, the user can confirm repeatedly registration when the user wants to confirm it. In these cases, the application unit 11 displays the notification screen based on the information stored in the history data storage unit 122. When the corresponding repeatedly registered telephone directory data is not deleted after issuing the notification, the information is held in the history data storage unit 122 after the communication is completed.

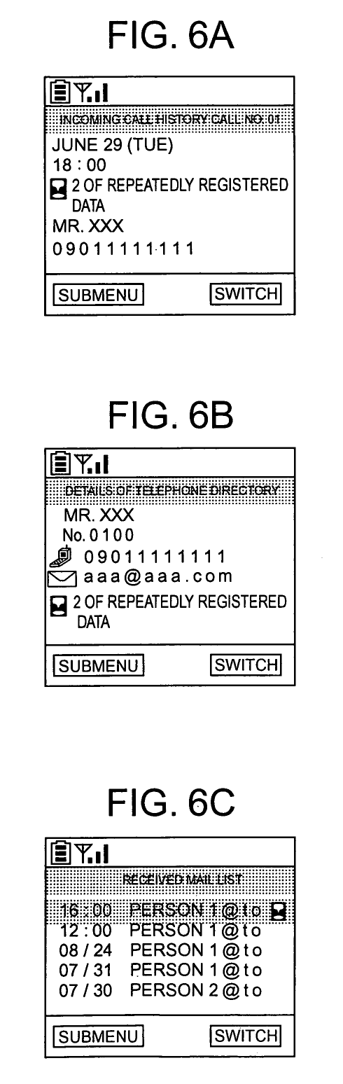

For example, the application unit 11 displays the notification screen for notifying that there is repeatedly registered data as shown in FIG. 6A when the incoming call history display instruction is inputted. Additionally, for example, when the display instruction of the telephone directory 121 is inputted, the notification screen is displayed as shown in FIG. 6B by the application unit 11. When the received mail listing display instruction is inputted, for example, the application unit 11 displays the notification screen as shown in FIG. 6C.

The application unit 11 has the well-known functions of displaying a incoming call history, displaying a received mail listing, and displaying the telephone directory 121. To display an incoming call history and received e-mail listing, the incoming call history of voice communication calls and received mail listing display are respectively recorded in the incoming call history storage unit and the received mail listing display storage unit of the data storage unit 12 (these units are not shown in the attached drawings). Practically, the notification screen shown in FIG. 6A uses the screen of incoming call history display depending on the input of an incoming call history display instruction, and the display indicating that there is repeatedly registered data is added to the screen. Similarly, the notification screen shown in FIG. 6B uses the screen of the display of the telephone directory 121, and the notification screen shown in FIG. 6C uses the screen of the received mail listing display.

For example, in the telephone directory 121 shown in FIG. 2, the telephone directory data of the registration number 0100 and the telephone directory data of the registration number 0110 are repeatedly registered. They have common telephone number of “09011111111”. In this case, the application unit 11 displays the well-known incoming call history display screen, and refer to the history data storage unit 122. When the telephone directory data relating to the corresponding incoming call history display instruction is repeatedly registered, for example, “! 2 of data repeatedly registered data” is displayed to announce the repeatedly registration. Thus, the incoming call history data is displayed about the corresponding telephone number as shown in FIG. 6A. The same holds true with FIGS. 6B and 6C.

At this time, as shown in FIG. 6A, the application unit 11 displays on the notification screen an icon indicating that telephone directory data is repeatedly registered, for example, “! (exclamation mark)” together with the message “2 of repeatedly registered data”. Thus, a user can be informed that there is repeatedly registration for the telephone number. FIG. 6B shows a similar screen. In FIG. 6C, the icon “!” is displayed beside a record of receiving any e-mail (for example, the first e-mail).

According to the reply (user instruction input) to the notifying process, the process of deleting repeatedly registered telephone directory data is performed according to the present invention. At this time, the repeated registered data deletion unit 112 deletes the telephone directory data to be deleted in the repeatedly registered telephone directory data. That is, the repeated registered data deletion unit 112 updates the incoming call processing information corresponding to the telephone directory data not to be deleted in the telephone directory 121 using the incoming call processing information corresponding to the telephone directory data to be deleted.

Therefore, in this example, the application unit 11 as a notification unit displays a notification screen notifying that there is repeatedly registered telephone directory data, and a contents screen displaying repeatedly registered telephone directory data. That is, the application unit 11 displays the contents screen according to the input of a predetermined instruction on the notification screen. Furthermore, the application unit 11 displays the instruction screen indicating the telephone directory data to be deleted according to the predetermined instruction input on the contents screen, and the selection screen indicating whether or not the incoming call processing information corresponding to the telephone directory data not to be deleted is to be updated using the incoming call processing information corresponding to the telephone directory data to be deleted.

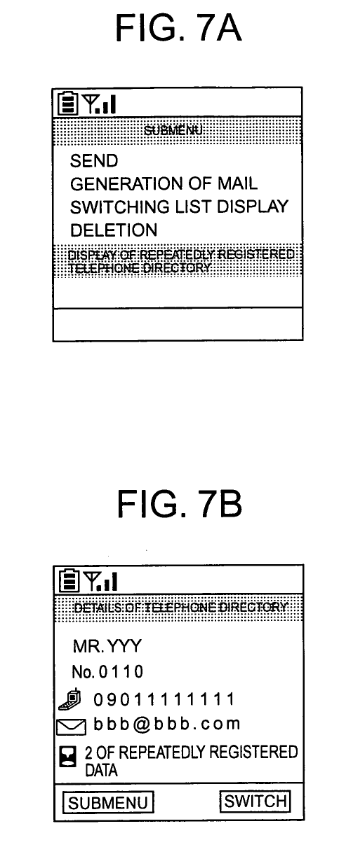

For example, when an item “submenu” is selected on the notification screen shown in FIG. 6B, the application unit 11 displays, for example, the submenu screen as shown in FIG. 7A. Although the item “submenu” is selected on the notification screen shown in FIGS. 6A and 6C, the same processes are performed. In addition, for example, when the inversion item is selected in the state in which “There is repeatedly registered telephone directory data” is displayed as an inverted display on the notification screen shown in FIGS. 5A and 5B, the application unit 11 displays the submenu screen of the notification screen as shown in FIG. 7A.

When an item “display of repeated registered telephone directory” is selected on the submenu screen of the notification screen shown in FIG. 7A, then the application unit 11 displays the contents screen displaying repeatedly registered telephone directory data as shown in FIG. 7B. The contents screen shown in FIG. 7B displays the telephone directory data of the registration number 0110 as repeatedly registered data of the telephone directory data of the registration number 0100 shown in FIG. 6B. The application unit 11 displays the notification screen shown in FIG. 6B and the contents screen shown in FIG. 7B by alternately switching by selecting the item “switch”.

When control is passed from FIGS. 5A and 5B to FIG. 7A, only the contents screen shown in FIG. 7B may be displayed, or the screen corresponding to the notification screen shown in FIG. 6B may be displayed for the received telephone number or e-mail, and it may be switched to the contents screen shown in FIG. 7B. On the screen corresponding to the notification screen shown in FIG. 6B, only the telephone number and “! 2 of repeatedly registered data” are displayed, and the remaining area may be kept blank. The description “2” refers to the number of cases obtained by adding incoming telephone numbers and so on to the telephone directory data existing in the telephone directory 121.

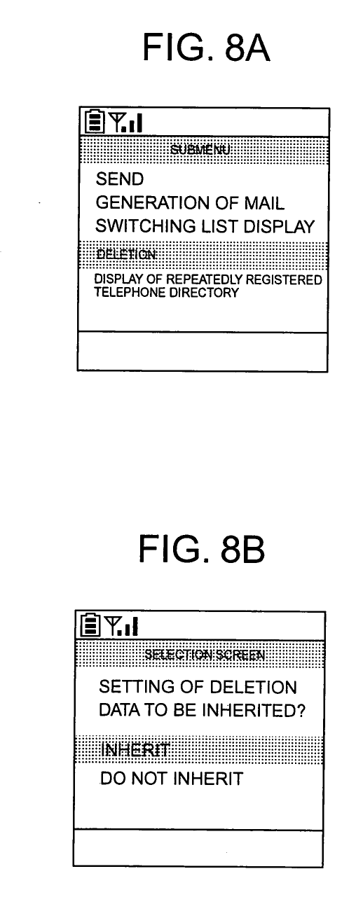

When the item “submenu” is selected on the contents screen shown in FIG. 7B, the application unit 11 displays the submenu screen of the contents screen as shown in FIG. 8A. A similar process is performed when the item “submenu” is selected on the notification screen shown in FIG. 6B. Therefore, FIG. 7A is identical to FIG. 8A. When the item “delete” is selected on the submenu screen of the contents screen as shown in FIG. 8A transferred from FIG. 7B, the telephone directory data (telephone directory data of the registration number 0110) relating to the contents screen is to be deleted. Therefore, the submenu screen of the contents screen (and the submenu screen of the notification screen) is a instruction screen indicating the telephone directory data to be deleted. When the item “delete” is selected on the submenu screen of the notification screen shown in FIG. 7A transferred from FIG. 6B, the telephone directory data of the registration number 0100 is to be deleted.

When the item “delete” is selected on the submenu screen of the contents screen shown in FIG. 8A, the application unit 11 displays the selection screen as shown in FIG. 8B. The selection screen shown in FIG. 8B is a submenu for deletion of the telephone directory data of the registration number 0110 shown in FIG. 7B. Therefore, when the item “inherit” is selected, the incoming call processing information (for example, incoming call setting, reception setting) of the telephone directory data of the registration number 0110 to be deleted is inherited to the telephone directory data of the registration number 0100 not to be deleted. That is, the incoming call processing information of the telephone directory data of the registration number 0100 is overwritten by the incoming call processing information of the telephone directory data of the registration number 0110 to be deleted.

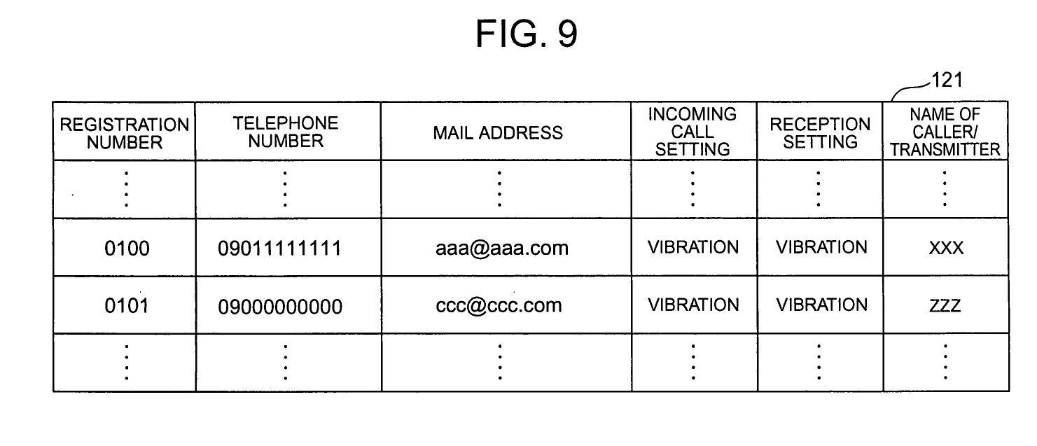

Thus, as shown in FIG. 9, the application unit 11 stores, for example, the settings of the telephone directory data of the registration number 0110 to be deleted as the settings of the registration number 0100 not to be deleted in the telephone directory 121 shown in FIG. 2. Additionally, not only the incoming call processing information but also the mail address, and so on of the telephone directory data to be deleted can also be inherited.

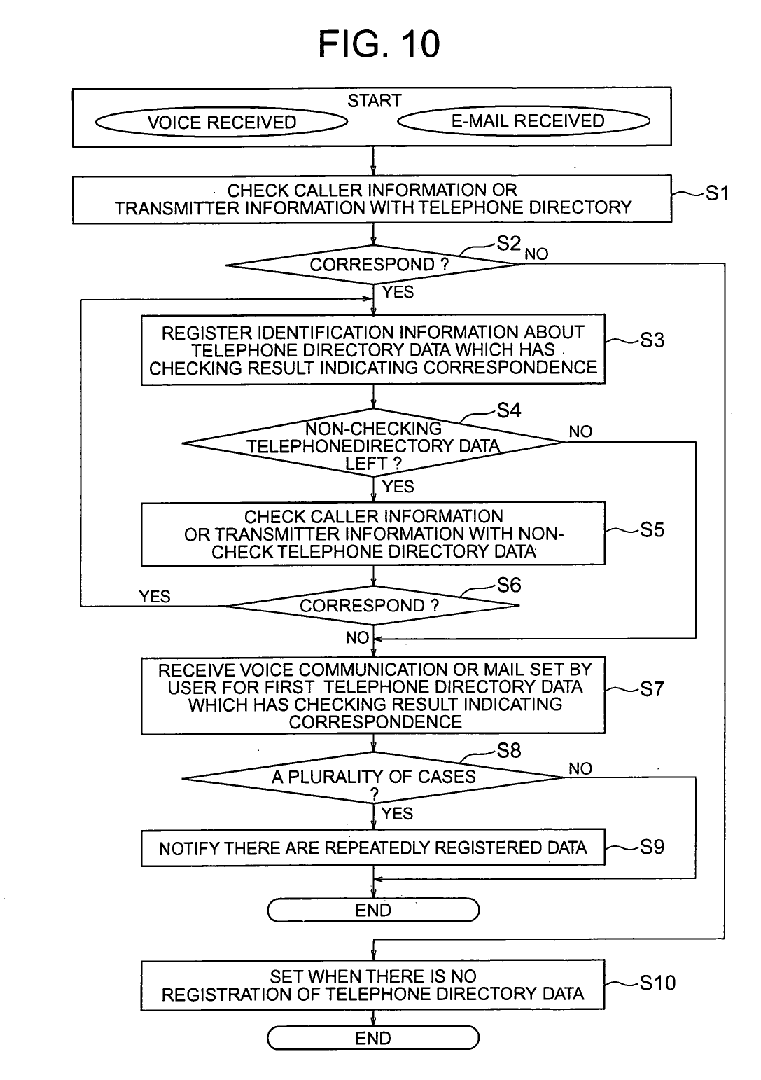

FIG. 10 is an explanatory diagram showing an example of a checking process of the telephone directory data according to the present invention, and an example of a checking process flow of the telephone directory data processed by (the telephone directory data checking unit 111 of) the application unit 11.

When the telephone 1 receives voice communication call or e-mail, the application unit 11 checks the caller information about voice communication or the transmitter information about e-mail with the telephone directory data of the telephone directory 121 (step S1), and judges whether or not there is corresponding (or hit) telephone directory data (step S2).

When there is no corresponding telephone directory data, the application unit 11 performs incoming call processing according to the incoming call processing information predetermined for the case in which there is no registered telephone directory data in the telephone directory 121 (hereinafter referred to also as operation processing) (step S10). Thus, a normal ringing tone is raised.

When there is corresponding telephone directory data found in step S2, the application unit 11 registers the identification information about the telephone directory data having the checking result which indicates correspondence in the repetition information storage unit 123 (step S3). Thus, the identification information is stored in the repetition information storage unit 123.

Then, the application unit 11 judges whether or not there is any telephone directory data not checked yet in the telephone directory 121 (step S4). When there is any telephone directory data not checked yet, the application unit 11 checks the caller information or the transmitter information with the telephone directory data not checked yet (telephone directory data after the data checked (hit) in step S1)(step S5). The application unit 11 judges whether or not there is telephone directory data having the checking result which indicates correspondence (step S6). When there is telephone directory data having the checking result which indicates correspondence, the processes in and after step S3 are repeated.

When there is no telephone directory data having the checking result which indicates correspondence in step S6, the application unit 11 refers to the repetition information storage unit 123, and performs the incoming call processing according to the predetermined incoming call processing information on the first telephone directory data having the checking result which indicates correspondence (step S7). Thus, a ringing tone corresponding to the first telephone directory data having the checking result which indicates correspondence is raised. As described above, the processes in and after step S3 and the process in step S7 may be processed practically in parallel.

Next, the application unit 11 refers to the repetition information storage unit 123, and judges whether or not there is a plurality of telephone directory data having the checking result which indicates correspondence (step S8). When there is only one case of telephone directory data having the checking result which indicates correspondence, the application unit 11 terminates the process. When there is a plurality of telephone directory data having the checking result which indicates correspondence, the application unit 11 performs a notifying process of notifying that there are repeatedly registered telephone directory data (step S9).

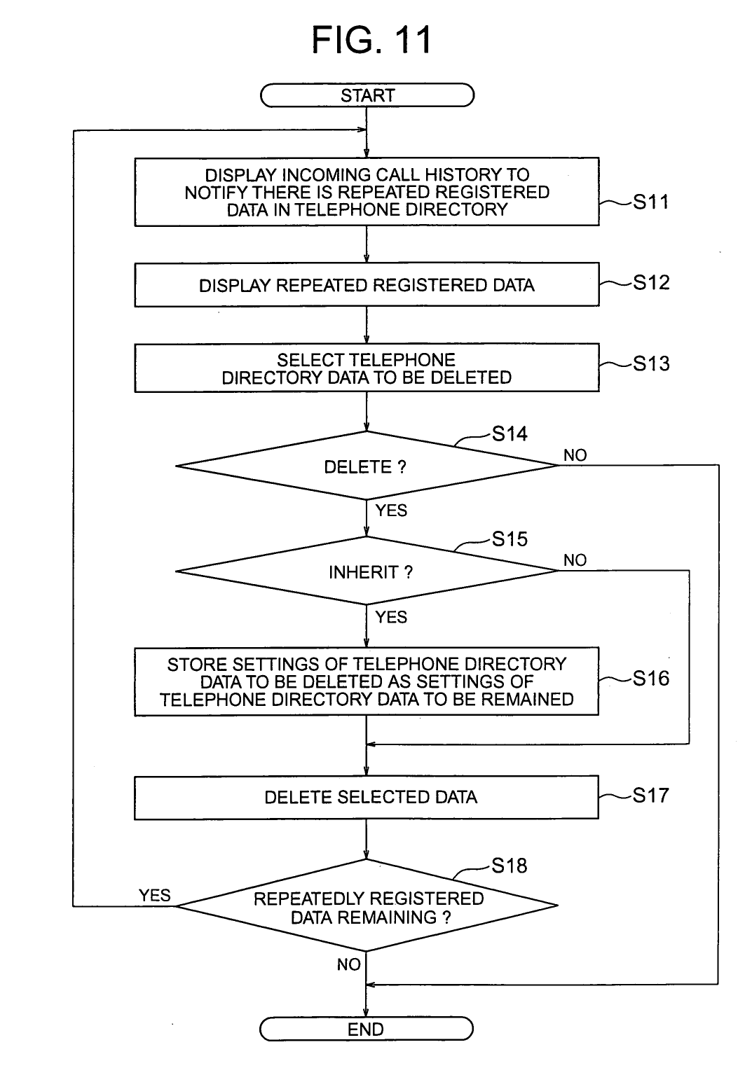

FIG. 11 is an explanatory diagram showing an example of a deleting process on repeatedly registered telephone directory data, and an example of the deleting process flow on the repeatedly registered telephone directory data performed by (the repeated registered data deletion unit 112 of) the application unit 11.

Upon receipt of, for example, an incoming call history display instruction, the application unit 11 refers to the history data storage unit 122 as shown in FIG. 6A, and displays an incoming call history notifying that there is repeatedly registered telephone directory data in the telephone directory 121 (step S11).

Then, the application unit 11 performs a repeatedly registered data display process based on the operation information inputted by the operation information input unit 14 (step S12). That is, as described above, the contents screen in FIG. 7B is displayed from the notification screen in FIG. 6A through the submenu screen in FIG. 7A.

Next, when the telephone directory data to be deleted is selected based on the operation information inputted by the operation information input unit 14 (step S13), the application unit 11 judges whether or not the deletion of the telephone directory data has been selected (step S14). That is, it is judged whether or not the item “delete” of the submenu (instruction screen) has been selected with the notification screen in FIG. 6B or the contents screen in FIG. 7B selected as described above. That is, it is judged which has been selected, the item “delete” in FIG. 7A or the item “delete” in FIG. 8A.

When the deletion of telephone directory data is not selected, the application unit 11 terminates the process. When the deletion of telephone directory data is selected, the application unit 11 judges whether or not the settings of the telephone directory data to be deleted are to be inherited (step S15). That is, on the selection screen shown in FIG. 8 after selecting the item “delete” in FIG. 7A (or the item “delete” in FIG. 8A), it is judged which has been selected, “inherit” or “do not inherit”.

When the settings of the deleted data are inherited, the application unit 11 stores the contents of the telephone directory data to be deleted as the contents of the telephone directory data not to be deleted (step S16), and deletes the telephone directory data to be deleted (selected data) (step S17). When the settings of the deleted data are not to be inherited, the application unit 11 omits the process in step S16, and performs the process in step S17.

Afterwards, the application unit 11 refers to the history data storage unit 122, and judges whether or not there is any identification information about the repeatedly registered telephone directory data (step S18). When there is any identification information remaining, the application unit 11 repeats the processes in and after step S11. When there is no remaining identification information, the process is terminated.

As described above, according to the telephone, the telephone directory data checking method, and the telephone directory data checking program of the present invention, all telephone directory data is searched without a user performing the searching operation, repeatedly registered telephone directory data is displayed to the user, and unnecessary telephone directory data can be deleted by the operation of the user. Furthermore, according to the present invention, the necessary portions of the telephone directory data to be deleted can be reflected by other telephone directory data, thereby adjusting the telephone directory data without the user inputting again the necessary partial data. Therefore, according to the present invention, the user can easily maintain and manage a telephone directory almost without any load of the user.

Thus, according to the present invention, it is quite easy for a user to maintain a telephone directory appropriately, thereby efficiently managing the telephone directory. Furthermore, according to the present invention, when a voice communication call or e-mail is received, user-unintended incoming call processing can be removed. Therefore, the reliability of a telephone directory can be remarkably enhanced. Thus, the convenience and reliability of a telephone can be much improved.

What is claimed is:

1. A telephone comprising:
A telephone directory registering at least a telephone directory data;
a storage unit;
a telephone directory data checking unit detecting one or more repeatedly registered telephone directory data by checking a caller information about a received voice communication or a transmitter information about a received e-mail with all telephone directory data registered in the telephone directory, and storing information for identification of the telephone directory data having a checking result which indicates correspondence in the storage unit every time when a checking result indicates correspondence; and
a notification unit notifying that the telephone directory data is repeatedly registered according to the information stored in the storage unit when the repeatedly registered telephone directory data is detected.

2. The telephone according to claim 1, wherein, after checking the caller information about the received voice communication or the transmitter information about the received e-mail with all telephone directory data, the telephone directory data checking unit performs an incoming call processing according to an incoming call processing information about the received voice communication or the received e-mail.

3. The telephone according to claim 2,
wherein the telephone directory data registered in the telephone directory is a data associated with an incoming call processing information used when the voice communication is received or when the e-mail is received, and
wherein the telephone directory data checking unit performs an incoming call processing according to an incoming call processing information corresponding to a first telephone directory data having the checking result which indicates correspondence.

4. The telephone according to claim 2, wherein the telephone directory data checking unit performs an incoming call processing according to an incoming call processing information corresponding to the telephone directory data having the checking result which indicates correspondence in a predetermined order.

5. The telephone according to claim 1,
wherein the telephone directory data registered in the telephone directory is a data associated with an incoming call processing information used when the voice communication is received or when the e-mail is received, and
wherein, immediately after detecting a first telephone directory data having the checking result which indicates correspondence with the caller information about the received voice communication or the transmitter information about the received e-mail, the telephone directory data checking unit performs an incoming call processing according to an incoming call processing information corresponding to the first telephone directory data having the checking result which indicates correspondence as the incoming call processing about the received voice communication or the received e-mail.

6. The telephone according to claim 1, wherein, when there is no telephone directory data having the checking result which indicates correspondence with the caller information about the received voice communication or the transmitter information about the received e-mail, the telephone directory data checking unit performs an incoming call processing according to a predetermined incoming call processing information as the incoming call processing about the received voice communication or the received e-mail.

7. The telephone according to claim 1, wherein the telephone directory data checking unit detects the repeatedly registered telephone directory data by a trigger of receiving the voice communication or the e-mail.

8. The telephone according to claim 1, wherein the notification unit further comprises a display unit displaying a notification screen notifying that the telephone directory data is repeatedly registered.

9. The telephone according to claim 1, wherein the notification unit notifies that the telephone directory data is repeatedly registered by a trigger of an incoming call of a voice communication or a reception of an e-mail or input of an incoming call history display instruction or input of a received mail listing display instruction or input of telephone directory display instruction.

10. The telephone according to claim 9,
wherein the storage unit further comprises first and second storage units, and
wherein the telephone directory data checking unit stores an information identifying the telephone directory data having the checking result which indicates correspondence in the first storage unit, and storing the information stored in the first storage unit after completing incoming call processing on the received voice communication or received e-mail in the second storage unit.

11. The telephone according to claim 10,
wherein, the notification unit further comprises a display unit displaying a notification screen notifying that the telephone directory data is repeatedly registered, and
wherein when the display unit displays the notification screen notifying that the telephone directory data is repeatedly registered by a trigger of a reception of the voice communication or the e-mail, the display unit displays the notification screen according to the information stored in the first storage unit, and, when the display unit displays the notification screen by a trigger of input of an incoming call history display instruction or input of a received mail listing display instruction or input of telephone directory display instruction, the display unit displays the notification screen according to the information stored in the second storage unit.

12. The telephone according to claim 9,
wherein the notification unit further comprises a display unit displaying a notification screen notifying that the telephone directory data is repeatedly registered, and
wherein the notification unit displays an icon indicating that the telephone directory data is repeatedly registered on the notification screen.

13. The telephone according to claim 1, further comprising:
a repeated registered data deletion unit deleting telephone directory data to be deleted from the repeatedly registered telephone directory data,
wherein the repeated registered data deletion unit updates an incoming call processing information corresponding to telephone directory data not to be deleted in the telephone directory by using an incoming call processing information corresponding to the telephone directory data to be deleted.

14. The telephone according to claim 13, wherein the notification unit further comprises a display unit displaying a notification screen notifying that the telephone directory data is repeatedly registered, and a contents screen displaying the repeatedly registered telephone directory data.

15. The telephone according to claim 14, wherein the notification unit displays the contents screen according to an input of a predetermined instruction on the notification screen.

16. The telephone according to claim 15, wherein the notification unit displays an instruction screen to which an instruction is inputted which indicates the telephone directory data to be deleted, and a selection screen to which an instruction is inputted which indicates whether or not the incoming call processing information corresponding to the telephone directory data not to be deleted is updated by using the incoming call processing information corresponding to the telephone directory data to be deleted, according to the predetermined instruction inputted on the contents screen.

17. A telephone directory data checking method for checking a telephone directory data registered in a telephone directory of a telephone, the method comprising:
detecting a repeatedly registered telephone directory data by checking a caller information about a received voice communication or a transmitter information about a received e-mail with all telephone directory data registered in the telephone directory;
storing information for identification of the telephone directory data having the checking result which indicates correspondence in a storage unit every time when the checking result indicates correspondence; and
notifying that the telephone directory data is repeatedly registered according to the information stored in the storage unit when the repeatedly registered telephone directory data is detected.

18. A telephone directory data checking program for checking telephone directory data registered in a telephone directory of a telephone having a computer, the program causing the computer to execute:
detecting a repeatedly registered telephone directory data by checking a caller information about a received voice communication or a transmitter information about a received e-mail with all telephone directory data registered in the telephone directory;
storing information for identification of the telephone directory data having the checking result which indicates correspondence in a storage unit every time when a checking result indicates correspondence; and
notifying that the telephone directory data is repeatedly registered according to the information stored in the storage unit when the repeatedly registered telephone directory data is detected.
